(19) United States
(12) Patent Application Publication
(10) Pub. No.: US 2018/0365732 A1
(43) Pub. Date: Dec. 20, 2018

(54) Providing Advertisements as Suggestions for Event Locations

(71) Applicant: Google Inc., Mountain View, CA (US)

(72) Inventors: Courtney Hampson, Mountain View, CA (US); Jason Robert Richard Sanio, Mountain View, CA (US)

(73) Assignee: Google Inc., Mountain View, CA (US)

(21) Appl. No.: 14/192,758

(22) Filed: Feb. 27, 2014

(51) Int. Cl. G06Q 30/02

(52) U.S. Cl. CPC G06Q 30/0261

(57) ABSTRACT

A system and method for providing advertisements as suggestions for event locations. Information associated with a scheduled event is received. The information includes an event title. In some embodiments, the information also includes a time of the even. In some embodiments, the information also includes a date of the event. The received information is analyzed. A database of advertisements is searched based on the analysis of the received information associated with the event. A relevant advertisement is identified. The relevant advertisement is sent for display as a suggestion for the event location. A selection of the advertisement may be received. In response to receiving the selection, the location information of the event may be updated based on the selected advertisement.

### BACKGROUND

The specification relates to generating a suggestion associated with a particular event. In particular, the specification relates to generating an advertisement of venue as a suggestion for a location for a particular event.

With the current use of on-line media and social media, most vendors and business owners are turning to the Internet to advertise their businesses. However, because there is an abundance of potential advertisements that may be generated with this increasing popularity of utilizing the Internet as a forum for advertising, consumers may be overwhelmed by irrelevant advertisements that appear during inopportune moments. Therefore, serving relevant advertisements to users at the appropriate time is essential.

### SUMMARY

A system and method for providing advertisements as suggestions for event locations. Information associated with a scheduled event is received. The information includes an event title. In some embodiments, the information also includes a time of the even. In some embodiments, the information also includes a date of the event. The received information is analyzed. A database of advertisements is searched based on the analysis of the received information associated with the event. A relevant advertisement is identified. The relevant advertisement is sent for display as a suggestion for the event location. A selection of the advertisement may be received. In response to receiving the selection, the location information of the event may be updated based on the selected advertisement.

In some embodiments, the specification describes a computer-implemented method comprising: receiving, with one or more processors, information from a first user associated with a scheduled event, the information including a title of the event, a date of the event, and a time of the event; analyzing, with the one or more processors, the information associated with the proposed event; searching, with the one or more processors, a database of advertisements to find a relevant advertisement based on the analyzed information; identifying, with the one or more processors, the relevant advertisement; and sending, with the one or more processors, the relevant advertisement for display, the relevant advertisement as a suggestion for a location of the event.

In some embodiments, the specification describes a system comprising one or more processors and a memory storing instructions that when executed by the one or more processors cause the system to: receive information from a first user associated with a scheduled event, the information including a title of the event, a date of the event, and a time of the event; analyze the information associated with the proposed event; search a database of advertisements to find a relevant advertisement based on the analyzed information; identify the relevant advertisement; and send the relevant advertisement for display. The relevant advertisement as a suggestion for a location of the event.

### BRIEF DESCRIPTION OF THE DRAWINGS

The specification is illustrated by way of example, and not by way of limitation in the figures of the accompanying drawings in which like reference numerals are used to refer to similar elements.

FIG. 1 is a block diagram illustrating an example of a system for providing an advertisement as a suggestion for an event location.

FIG. 2 is a block diagram illustrating an example computing device including a suggestion application according to one embodiment.

FIG. 3 is a flow diagram of an example of a method for providing an advertisement as a suggestion for an event location to one embodiment.

FIG. 4 is a flow diagram of of another example of a method for providing an advertisement as a suggestion for an event location to one embodiment.

### DETAILED DESCRIPTION

The specification describes a system and method for providing an advertisement as a suggestion for an event location. In some embodiments, a user may create an event via the social network engine 204. Upon creating the event, the user may identify the event by entering information associated with the event. Such information may include, the time of the event, the event location, and at least one invitee or participant. The event analysis module 206 receives the information associated with the scheduled event. The event analysis module 206 analyzes the information associated with the scheduled event. The advertisement identification 208 searches an advertisement database 104 and identifies relevant advertisements based on the analysis. The advertisement delivery module 210 then sends the identified advertisement to user devices for display. The advertisements are associated with venues and are suggestions of locations for the event. In some embodiments, the event update module 212 receives a selection of the advertisement from the user and updates the location information of the event based on the selected advertisement.

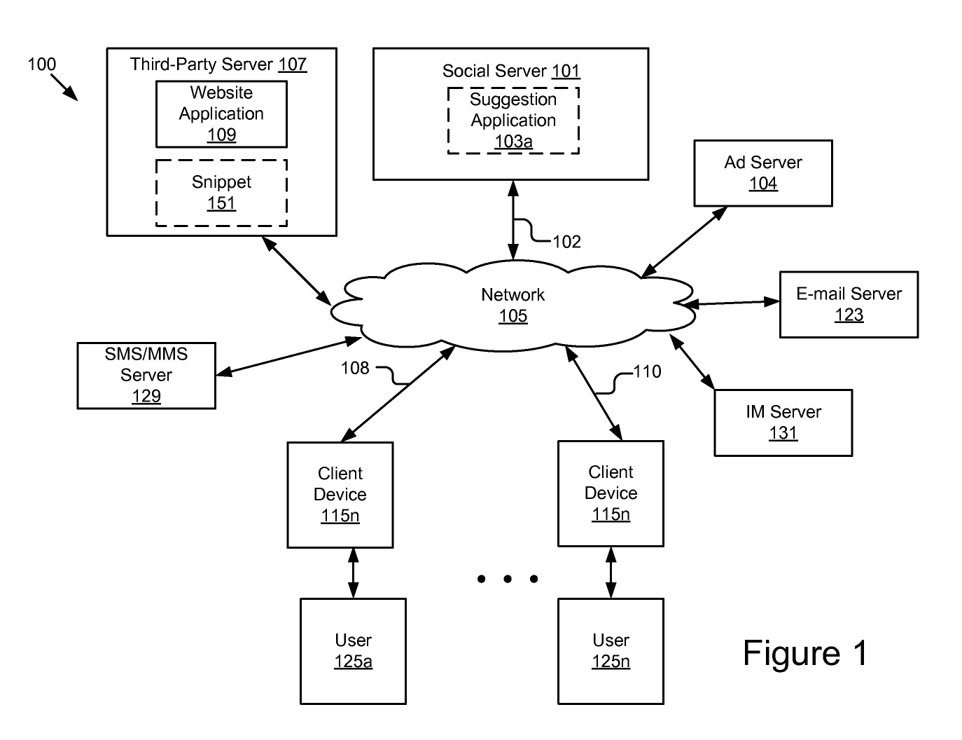

FIG. 1 is a block diagram illustrating an example of a system for notifying a participant of a change in event information according to one embodiment. In some embodiments, the system notifies a participating of a change based on the level of urgency of the change. In some embodiments, the mode of delivery depends on the level of urgency. The illustrated description of the system 100 includes user devices 115a . . . 115n that are accessed by users 125a . . . 125n, a social network server 101, a third-party server 107, an advertisement server 104, an electronic messaging server 123, a short message service (SMS)/multimedia messaging service (MMS) server 129 and an instant message (IM) server 131. In the illustrated embodiment, these entities of the system 100 are communicatively coupled via a network 105. In FIG. 1 and the remaining figures, a letter after a reference number, for example “115a” is a reference to the element having that particular reference number. A reference number in the text without a following letter, for example “115,” is a general reference to any or all instances of the element bearing that reference number.

The network 105 may be a conventional type network, wired or wireless, and may have any number of configurations for example a star configuration, token ring configuration or other configurations known to those skilled in the art. Furthermore, the network 105 may comprise a local area network (LAN), a wide area network (WAN) (e.g., the Internet), and/or any other interconnected data path across which multiple devices may communicate. In some embodiments, the network 105 may be a peer-to-peer network. The network 105 may also be coupled to or includes portions of a telecommunications network for sending data in a variety of different communication protocols. In some other embodiments, the network 105 includes Bluetooth communication networks or a cellular communications network for sending and receiving data for example via SMS/MMS, hypertext transfer protocol (HTTP), direct data connection, WAP, e-mail, etc. While only one network 105 is illustrated, persons with ordinary skill in the art will recognize that any number of networks may be coupled to the above mentioned entities.

In some embodiments, a suggestion application 103a may be operable on the social network server 101, which is coupled to the network 105 via signal line 102. The social network server 101 can be a hardware server that includes a processor, a memory and network communication capabilities. The social network server 101 sends and receives data to and from one or more of the user devices 115a, 115n and the third-party server 107 via the network 105. The social network server 101 also includes a social network application (not pictured) that can be part of the suggestion application 103 or a standalone application. A social network can be any type of social structure where the users are connected by a common feature. The common feature includes relationships/connections, e.g., friendship, family, work, an interest, etc. The common features are provided by one or more social networking systems, such as those included in the architecture 100, including explicitly defined relationships and relationships implied by social connections with other online users, where the relationships form a social graph. In some examples, the social graph can reflect a mapping of these users and how they are related. Furthermore, it should be understood that the social network server 101 may be representative of one social network and that there may be multiple social networks coupled to the network 105, each having its own server, application and social graph. For example, a first social network may be more directed to business networking, a second may be more directed to or centered on academics, a third may be more directed to local business, a fourth is directed to dating and others are of general interest or a specific focus.

In some embodiments, a snippet 151 can be stored on a third-party server 107, which is communicatively connected to the network 105 via signal line 106. The third-party server 107 includes an application for generating a third-party website (not shown). The snippet 151 can be code or routines configured to enable the software included in the third-party server 107 to communicate with the suggestion application 103 so that the software can use the service provided by the suggestion application 103. For example, the snippet 151 communicates with the suggestion application 103 to generate notifications to participants of changes in event information. The third-party website can be catering to specific services, such as, services for making online reservations, services for setting up and creating events, etc. The users visiting the third-party website (or users authenticated through the social network server 101) can send messages to their connections (i.e. user recipients) within their respective social networks about at least one aspect of the service offered by the third-party website hosted by the third-party website

In some other embodiments, the snippet 151 includes code from a group of C, C++, Java, CSS and PHP. Furthermore, while only one snippet 151 is shown in the third-party server 107, the third-party server 107 could include one or more snippets 151. Similarly while only one third-party server 107 is shown, the system 100 can include one or more third-party servers 107.

The user devices 115a, 115n in FIG. 1 are used by way of example. Although only two user devices 115 are illustrated, persons of ordinary skill in the art will recognize that any numbers of user devices 115 are available to any number of users 125. The users 125a, 125n interact with the user devices 115a, 115n. In some embodiments, the suggestion application 103b may be stored on the user device 115a which is connected to the network 105 via signal line 108. In some other embodiments, the suggestion application 103 can be split into some components that are stored on the user device 115a and some components that are stored on the social network server 101. For example, the suggestion application 103a on the social network can store user information and receive messages and notifications and the suggestion application 103b on the user device 115a is a thin-client application for displaying the messages and notifications.

The user device 115 can be any computing device that includes a memory and a processor. For example, the user devices 115 can be a laptop computer, a desktop computer, a tablet computer, a mobile telephone, a personal digital assistant, a mobile email device, a portable game player, a portable music player, a television with one or more processors embedded therein or coupled thereto, a device that is worn by the user (e.g., a smart watch, part of a clip, or part of jewelry) or any other electronic device capable of accessing the network 105, etc.

The advertisement server 104 may include a processing circuit including a processor 120 and a memory 122. In some implementations, advertisement server 104 may include several computing devices (e.g., a data center, a network of servers, etc.). In such a case, the various devices of advertisement server 104 may be in electronic communication, thereby also forming a processing circuit (e.g., processor 120 includes the collective processors of the devices and memory 122 includes the collective memories of the devices).

Advertisement server 104 may provide digital advertisements to user devices 115a, 115n. In some implementations, an advertisement from advertisement server 104 may be provided via network 105. For example, a content source (not shown) may provide a webpage to user devices 115a, 115n, in response to receiving a request for a webpage from user devices 115a, 115n. In some implementations, an advertisement from advertisement server 104 may be provided to user devices 115a, 115n indirectly. For example, the content source may receive advertisement data from advertisement server 104 and use the advertisement as part of the webpage data provided to user devices 115a, 115n. In other implementations, an advertisement from advertisement server 104 may be provided to user devices 115a, 115n directly. For example, the content source may provide webpage data to user devices 115a, 115n that includes a command to retrieve an advertisement from advertisement server 104. On receipt of the webpage data, user devices 115a, 115n may retrieve an advertisement from advertisement server 104 based on the command and display the advertisement when the webpage is rendered on a display.

Advertisement server 104 may store advertisements of third party vendors. The advertisements may be associated with decriptions or other relevant information about the advertisement.

The suggestion application 103 can be software including routines for providing advertisements as suggestions for event locations. In some embodiments, the suggestion application 103 can be implemented using hardware including a field-programmable gate array (FPGA) or an application-specific integrated circuit (ASIC). In other embodiments, the suggestion application 103 can be implemented using a combination of hardware and software.

In some embodiments, the suggestion application 103 registers a first user and a second user on a third-party website by providing the first user and the second user with login credentials. The suggestion application 103 receives first user and second user activity on the third-party website responsive to authenticating the first user and the second user on the third-party website. The suggestion application 103 identifies an interaction between the first user and the second user on the third-party website and determines the context for the interaction between the first user and the second user on the third-party website. The suggestion application 103 identifies a group that the first user created on the social network based on the identified context. The suggestion application 103 provides a suggestion to the first user that the first user add the second user to the group.

In other embodiments, the suggestion application 103 registers a first user and a second user on by providing the first user and the second user with login credentials from a first social network. The suggestion application 103 identifies a first group that the first user added the second user to on the first social network. The suggestion application 103 receives first user and second user activity on a second social network responsive to authenticating the first user and the second user on the second social network using the login credentials. The suggestion application 103 identifies an interaction between the first user and the second user on the second social network and determines the context for the interaction between the first user and the second user on the second social network. The suggestion application 103 identifies a second group that the first user created on the first social network based on the identified context. The suggestion application 103 provides a suggestion to the first user that the first user add the second user to the group.

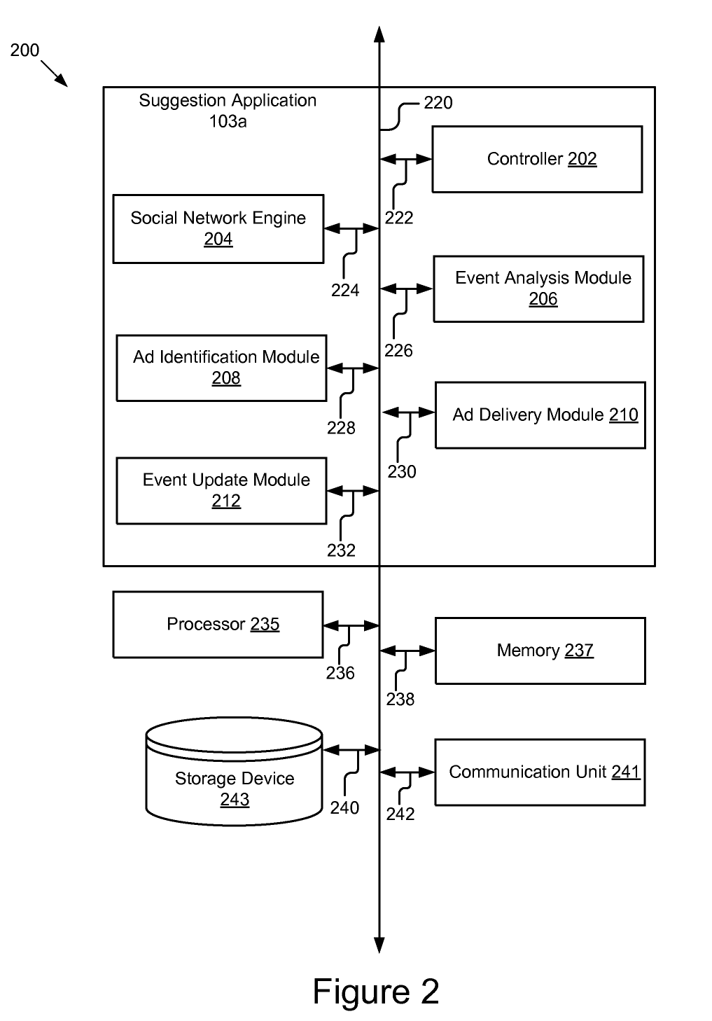

The suggestion application 103 receives information related to an event that was created by a user. The suggestion application 103 analyzes the information and identifies relevant information about the event. Based on the analysis the suggestion application 103 searches the advertisement server 104 or storage device 243 to identify relevant advertisements for places that can be appropriate locations for the event. The suggestion application 103 identifies relevant advertisements associated with a location that could be a location for the created event. The suggestion application 103 sends the identified location to the user devices 115a, 115n as a suggestion for the event location. The suggestion application 103 is described in further detail below with reference to FIG. 2.

Referring now to FIG. 2, a block diagram of a computing device 200 is illustrated that includes a processor 235, a memory 237, a communication unit 241 and a storage device 243 according to some examples. The components of the computing device 200 are communicatively coupled by a bus 220. The computing device 200 can be a social network server 101 or a user device 115.

The processor 235 includes an arithmetic logic unit, a microprocessor, a general-purpose controller or some other processor array to perform computations and provide electronic display signals to a display device. The processor 235 is coupled to the bus 220 via signal line 236 for communication with the other components. Processor 235 may process data signals and may comprise various computing architectures including a complex instruction set computer (CISC) architecture, a reduced instruction set computer (RISC) architecture, or an architecture implementing a combination of instruction sets. Although only a single processor is shown in FIG. 2, multiple processors may be included. The processing capability may be limited to supporting the display of images and the capture and transmission of images. The processing capability might be enough to perform more complex tasks, including various types of feature extraction and sampling. It will be obvious to one skilled in the art that other processors, operating systems, sensors, displays and physical configurations are possible.

The memory 237 stores instructions and/or data that may be executed by processor 235. The memory 237 is coupled to the bus 220 via signal line 238 for communication with the other components. The instructions and/or data may include code for performing any and/or all of the techniques described herein. The memory 237 may be a dynamic random access memory (DRAM) device, a static random access memory (SRAM) device, flash memory or some other memory device known in the art. In one embodiment, the memory 237 also includes a non-volatile memory or similar permanent storage device and media for example a disk drive, a CD-ROM device, a DVD-ROM device, a DVD-RAM device, a DVD-RW device, a flash memory device, or some other mass storage device known in the art for storing information on a more permanent basis.

The communication unit 241 transmits and receives data to and from at least one of the user device 115 and the social network server 101 depending upon where the suggestion application 103 is stored. The communication unit 241 is coupled to the bus 220 via signal line 242. In some embodiments, the communication unit 241 includes a port for direct physical connection to the network 105 or to another communication channel. For example, the communication unit 241 includes a USB, SD, CAT-5 or similar port for wired communication with the user device 115. In some other embodiments, the communication unit 241 includes a wireless transceiver for exchanging data with the user device 115 or any other communication channel using one or more wireless communication methods, such as IEEE 802.11, IEEE 802.16, BLUETOOTH® or another suitable wireless communication method.

In some embodiments, the communication unit 241 includes a cellular communications transceiver for sending and receiving data over a cellular communications network such as via short messaging service (SMS), multimedia messaging service (MMS), hypertext transfer protocol (HTTP), direct data connection, WAP, e-mail or another suitable type of electronic communication. In some other embodiments, the communication unit 241 includes a wired port and a wireless transceiver. The communication unit 241 also provides other conventional connections to the network for distribution of files and/or media objects using standard network protocols such as TCP/IP, HTTP, HTTPS and SMTP as will be understood to those skilled in the art.

The storage device 243 can be a non-transitory memory that temporarily stores data used by the suggestion application 103, for example, a cache. The storage device 243 may be a dynamic random access memory (DRAM) device, a static random access memory (SRAM) device, flash memory or some other memory device known in the art. In some embodiments, the storage device 243 also includes a non-volatile memory or similar permanent storage device and media such as a hard disk drive, a floppy disk drive, a CD-ROM device, a DVD-ROM device, a DVD-RAM device, a DVD-RW device, a flash memory device, or some other mass storage device known in the art for storing information on a more permanent basis. In the illustrated embodiment, the storage device 243 is communicatively coupled by the bus 220 for communication with the other components of the computing device 200 via signal line 240. Although only one storage device is shown in FIG. 2, multiple storage devices may be included. In another embodiment, the storage device 243 may not be included in the computing device 200 and can be communicatively coupled to the computing device 200 via the network 105.

In some embodiments, the storage device 243 stores interactions of users of the social network. In some embodiments, the storage device 243 stores interactions of users of third-party websites. In some embodiments, the storage device 243 stores the message sent by a sender to one or more user recipients on the social network. For example, the request can be a game invitation, a review, a status update, etc. In some embodiments, the storage device 243 stores data including daily habits, routines and activities determined for the one or more users on the social network. In some embodiments, the storage device 243 stores the data including groups of context and real time context associated with the one or more users. The data stored in the storage device 243 is described below in more detail. In some embodiments, the storage device 243 may store other data for providing the functionality described herein.

In some embodiments, the suggestion application 103 includes a controller 202, a social network engine 204, an event analysis module 206, an advertisement identification module 208, an advertisement delivery module 210 and an event update module 212.

The controller 202 can be software including routines for receiving data via the communication unit 241, routing the data to the appropriate engine or module and transmitting responses from the engine or module to the communication unit 241 for transmission to the user device 115 or the social network server 101. In some embodiments, the controller 202 can be a set of instructions executable by the processor 235 to provide the functionality described below for handling communications between the suggestion application 103 and other components of the computing device 200. In some other embodiments, the controller 202 can be stored in the memory 237 of the computing device 200 and can be accessible and executable by the processor 235. In either of the embodiments, the controller 202 may be adapted for cooperation and communication with the processor 235 and other components of the computing device 200 via signal line 222.

In some embodiments, the controller 202 identifies the type of data being received and transmits the data to the appropriate engine or module of the suggestion application 103. For example, the controller 202 receives information from the social network server 101 for rendering a user interface of the social network and transmits the information to the notification delivery engine 212. In some other embodiments, the controller 202 receives user inputs and user actions submitted by the user 125 from the user device 115. The controller 202 sends the user actions and the user inputs to the appropriate engine or module of the suggestion application 103.

In some embodiments, the controller 202 receives information from other components of the suggestion application 103 and transmits the information to the appropriate component in the system 100 via the communication unit 241. For example, the controller 202 receives graphical data for generating a user interface displaying a message from the user interface engine 212. The controller 202 transmits the graphical data associated with displaying the message to a display device (not shown) that is part of the user device 115. In another example, the controller 202 receives information including context data associated with an interaction between users from the advertisement identification 208. The controller 202 transmits the information including context data to the event update module 212 for providing a group suggestion to the user.

In some embodiments, the controller 202 receives data from components of the suggestion application 103 and stores the data in the storage device 243. For example, the controller 202 receives a data including context associated interactions between users from the advertisement identification 208 and stores them in the storage device 243. In some other embodiments, the controller 202 retrieves data from the storage device 243 and sends the data to other components of the suggestion application 103.

The social network engine 204 can be software including routines for generating and managing a social network. In some embodiments, the social network engine 204 can also be software including routines for allowing users to create and schedule events and invite participants to the scheduled events. In some embodiments, the social network engine 204 can a set of instructions executable by the processor 235 to provide the functionality described below for generating and managing a social network. In some other embodiments, the social network engine 204 can be stored in the memory 237 of the computing device 200 and can be accessible and executable by the processor 235. In either of the embodiments, the social network engine 204 can be adapted for cooperation and communication with the processor 235, the controller 202, the advertisement delivery module 210 and other components of the suggestion application 103 via signal line 224.

A social network can be a type of social structure where the relationships between the users 125 are included in a social graph. In some embodiments, the social graph includes a social affinity between users. For example, when a first user follows a second user, they have a first-degree relationship. When the second user follows a third user that the first user does not follow, the first user has a second-degree relationship with the third user. The lower the degree of separation between users, the more they share social affinity. In some embodiments, social affinity is also a measure of how many people are connected between users. For example, two users that are associated with the same five people could have a higher affinity than two users that are both associated with only one person.

In some embodiments users are connected in the social network by being friends. For example, users A and B can have reciprocal friendships with each other. In other embodiments, the relationships can be single directional, for example, when user A chooses to followed updates posted by user B. If user B chooses to follow user A, the relationship can be described as bi-directional or multi-directional. User B can choose to share updates with the public, which results in user A being able to view the update, or user B can share the updates with only people that user B follows. In some embodiments these relationships can be divided into groups on the social network based on context. Some areas of this disclosure refer to such groups as social groups. The groups can be used by the user to share information or send messages within the social network that is directed to that group. For example, user A can create an acquaintance group of users that user A wants to view updates from, but that user A does not know very well. In another example, user A can create a group of students taking the same class, e.g. a study group or people helpful for networking. In such examples, user A can use the created group to share information within or send messages directly to the members of the group.

The social network engine 204 manages the social network by handling registration of users, publication of content (e.g. posts, comments, photos, links, check-ins, etc.), hosting multi-user communication sessions, managing of groups, managing different sharing levels, updating the social graph, etc. The social network engine 204 registers a user by receiving information such as a username and password and generates a user profile that is associated with the user and stored as part of the social graph. In one embodiment, the user profile includes additional information about the user including interests (e.g. soccer, reading, food, subscriptions, gaming, etc.), activities (e.g. search history, indications of approval, posts, comments, multi-player online gaming, etc.), work (e.g., doctor, engineer, lawyer, research scientist, etc.), education (e.g., engineering, medicine, law, business, etc.) and demographics (e.g. age, ethnicity, location, etc.), etc. The social network engine 204 stores the user profile in the storage device 243.

In some embodiments, the social network engine 204 receives a request including login information for authentication. For example, the social network engine 204 receives a login request including a username and password from a user for logging into a social network. The social network engine 204 identifies the requesting user based on the login information associated with the login. In some other embodiments, the social network engine 204 communicates with the snippet 151 stored in the third-party server 107 and authenticates the user logging into the third-party website using the same credentials. In some embodiments, the social network engine 204 receives Application Programming Interface (API) requests generated by the snippet 151 stored on the third-party server 107. The API requests retrieve information about the user (for e.g., profile photo and name) and connect the user with his or her social connections on the social network. In some other embodiments, the social network engine 204 receives a message from the snippet 151 on the third-party server 107. The message is sent to specific recipients on the social network from a sender logged into the third-party website. For example, a sender is connected to the specific recipients on the social network and sends an invitation to an event that the sender created. The social network engine 204 receives information from the delivery notification module 212 to generate notifications of changes of a scheduled event. In some embodiments, the social network engine 204 allows users to schedule events and invite other users to those events. In some embodiments, the social network engine 204 allows users to identify and enter information associated with the event to schedule the event and invite participants. In some embodiments, such information may include the time of the event, the title of the event or the place of the event. In some embodiments, such information may include the description of the event. In some embodiments, such information may include the the participants or invitees of the event.

The event analysis module 206 can be software including routines for analyzing information associated with scheduled events. In some embodiments, the event analysis module 206 can be a set of instructions executable by the processor 235 to provide the functionality described below for analyzing information associated with scheduled events. In some other embodiments, the event analysis module 206 can be stored in the memory 237 of the computing device 200 and can be accessible and executable by the processor 235. In either of the embodiments, the event analysis module 206 can be adapted for cooperation and communication with the processor 235, the social network engine 204, the advertisement identification module 208 and other components of the suggestion application 103 via signal line 226.

In some embodiments, the event analysis module 206 receives information associated with a schedule event. In some embodiments, the information includes the event title, the date of the event and the time of the event. In some embodiments, the information also includes the number of participants or invitees. In some embodiments, the information also includes a description of the event. In some embodiments, the participant may be the even creator. In some embodiments, the participant may be an invitee or an attendee.

In some embodiments, the event analysis module 206 analyzes the information associated with the created event. In some embodiments, the event analysis module 206 analyzes the event title and determines key words associated with the title. For example, the event title may be “John's Birthday Party” and the event analysis module 206 may determines that the word “birthday” is a keyword. This determination may be based on a comparison of a list of keywords. In some embodiments, the event analysis module 206 analyzes the event description and determines keywords appearing in the description.

In some embodiments, the event analysis module 206 analyzes the event time to determine relevant information associated with the time of the event. In some embodiments, the event analysis module 206 analyzes the event time to determine relevant information associated with the time of the event. In some embodiments, the event analysis module 206 analyzes the number of participants to determine relevant information associated with the number of participants. In some embodiments, the event analysis module 206 analyzes all or a combination of the aforementioned pieces of information associated with the event to determine relevant information about the event.

In some embodiments, the event analysis module 206 receives information about the creator of the event that was provided by the event creator.

The advertisement identification module 208 can be software including routines for identifying advertisements based on the analysis of the event information. In some embodiments, the advertisement identification module 208 can be a set of instructions executable by the processor 235 to provide the functionality described below for identifying advertisements based on the analysis of the event information. In some other embodiments, the advertisement identification 208 can be stored in the memory 237 of the computing device 200 and can be accessible and executable by the processor 235. In either of the embodiments, the advertisement identification 208 can be adapted for cooperation and communication with the processor 235, the social network engine 204, the event analysis module 206, the event update module 212 and other components of the suggestion application 103 via signal line 228.

In some embodiments, the advertisement identification module 208 may communicate with and search the advertisement server 104 to identify the relevant advertisement based on the analysis of the event information. In some embodiments, the advertisement identification module 208 may communicate with and search for advertisements stored in the storage device 243. In some embodiments, the advertisement identification module 208 identifies advertisements of venues that would serve as appropriate locations for the created event. In such embodiments, the identification is based on the information associated with the particular event. For example, the event analysis module 206 received event information, such as an event title “Kids Birthday party” and event date of Saturday and event time of noon. Based on the analysis of this information, the advertisement identification module 208 identifies advertisements of venues that would be appropriate for a lunchtime children's birthday party that is open on the weekends.

The advertisement delivery module 212 can be software including routines sending the identified advertisement as a suggestion for the location of the event. In some embodiments, the advertisement delivery module 210 can be a set of instructions executable by the processor 235 to provide the functionality described below for sending the identified advertisement as a suggestion for the location of the event. In some other embodiments, the advertisement delivery module 210 can be stored in the memory 237 of the computing device 200 and is accessible and executable by the processor 235. In either of the embodiments, the advertisement delivery module 210 can be adapted for cooperation and communication with the processor 235 and other components of the suggestion application 103 via signal line 230.

In some embodiments, the advertisement delivery module 210 receives identified advertisement from the advertisement identification 208. In some embodiments, the advertisement delivery module 210 sends the identified advertisement to the appropriate user devices 115a/115n. In some embodiments, the advertisement delivery module 210 sends the identified advertisement to the appropriate client devices 115a/115n via a particular delivery method.

In some embodiments, the mode of notification is via email. In some embodiments, the mode of notification is generating a notification within a social network portal of the participant. In some embodiments, the mode of notification is sending an SMS message.

The event update module 212 can be software including routines for updating the location information of the event based on a selection of the identified advertisement. In some embodiments, the event update module 212 can be a set of instructions executable by the processor 235 to provide the functionality described below for updating the location information of the event based on a selection of the identified advertisement. In some other embodiments, the event update module 212 can be stored in the memory 237 of the computing device 200 and can be accessible and executable by the processor 235. In either of the embodiments, the event update module 212 can be adapted for cooperation and communication with the processor 235, the social network engine 204, event analysis module 206, the advertisement identification 208 and other components of the suggestion application 103 via signal line 232.

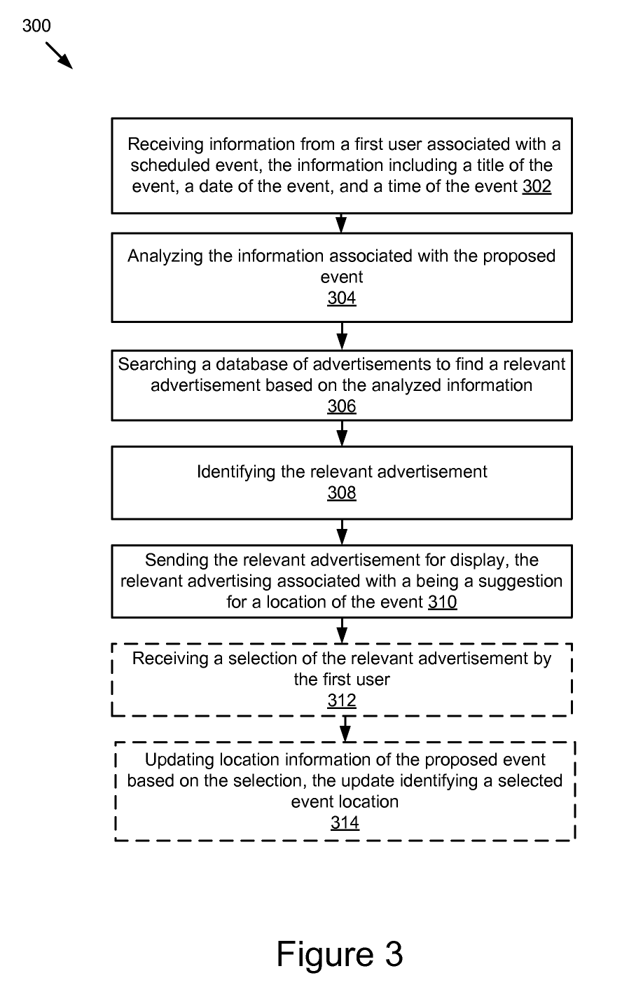

FIG. 3 is a flow diagram of an example of a method 300 for providing an advertisement as a suggestion for an event location to one embodiment. The suggestion application 103, as described above, includes a social network module 204, an event analysis module 206, an advertisement identification 208, an advertisement delivery module 210 and a event update module 212. In some embodiments, a user may create an event via the social network engine 204. Upon creating the event, the user may identify the event by entering information associated with the event. Such information may include, the title of the event, the date of the event, the time of the event and the number of participants or invitees. The event analysis module 206 receives 302 the information associated with the scheduled event. The event analysis module 206 analyzes 304 the information associated with the scheduled event. The advertisement identification 208 searches 306 a database of advertisements to find a relevant advertisement based on the analyzed information. The advertisement identification 208 identifies 308 the relevant advertisement. The advertisement delivery module 210 sends 310 the identified relevant advertisement for display as a suggestion for the location of the event.

In some embodiments, the event update module 212 receives 312 a selection of the identified relevant advertisement by a user. In such embodiments, in response to receiving the selection, the event update module 212 updates 314 the location information of the event based on the selection. The update identifies the selected event location.

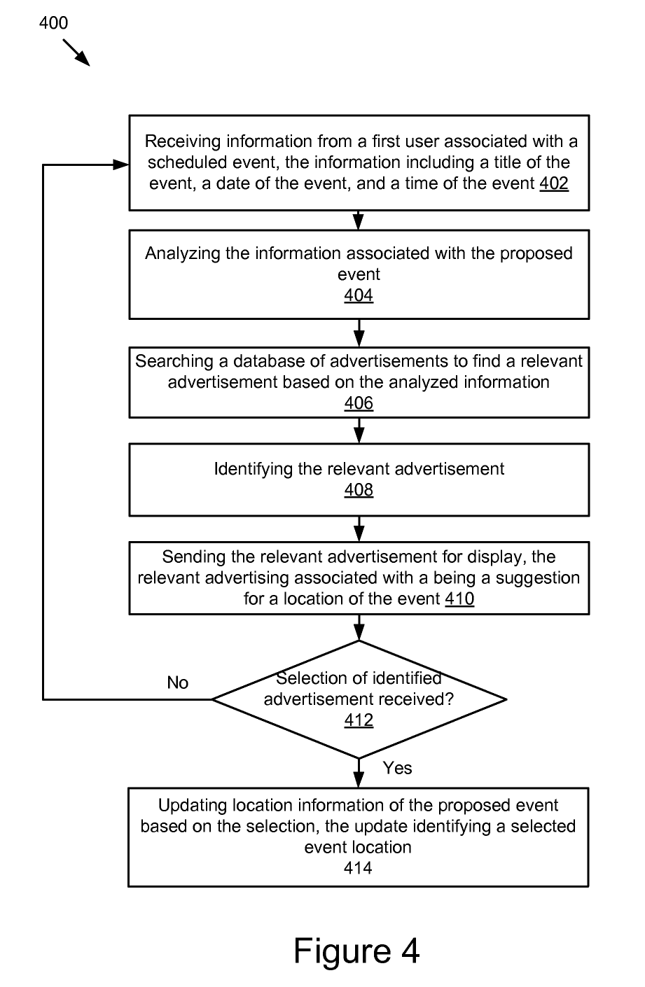

FIG. 4 is a flow diagram of of another example of a method 400 for providing an advertisement as a suggestion for an event location to one embodiment. The suggestion application 103, as described above, includes a social network module 204, an event analysis module 206, an advertisement identification 208, an advertisement delivery module 210 and a event update module 212. In some embodiments, a user may create an event via the social network engine 204. Upon creating the event, the user may identify the event by entering information associated with the event. Such information may include, the title of the event, the date of the event, the time of the event and the number of participants or invitees. The event analysis module 206 receives 402 the information associated with the scheduled event. The event analysis module 206 analyzes 404 the information associated with the scheduled event. The advertisement identification 208 searches 406 a database of advertisements to find a relevant advertisement based on the analyzed information. The advertisement identification 408 identifies 308 the relevant advertisement. The advertisement delivery module 210 sends 410 the identified relevant advertisement for display as a suggestion for the location of the event.

In some embodiments, the event update module 212 determines 412 whether a selection of the identified relevant advertisement was received from a user or client device 115a, 115n. If no selection was received (412—No), the process begins again with step 402. If a selection of the identified advertisement is received (412—Yes) by the event update module 212, the event update module 212 updates 414 the location information of the event based on the selection. The update identifies the selected event location.

In the above description, for purposes of explanation, numerous specific details are set forth in order to provide a thorough understanding of the specification. It will be apparent, however, to one skilled in the art that the invention can be practiced without these specific details. In other instances, structures and devices are shown in block diagram form in order to avoid obscuring the description. For example, the present embodiment is described in one embodiment below primarily with reference to user interfaces and particular hardware. However, the present embodiment applies to any type of computing device that can receive data and commands, and any peripheral devices providing services.

Reference in the specification to “some embodiments” or “an instance” means that a particular feature, structure, or characteristic described in connection with the embodiment is included in at least some embodiment of the description. The appearances of the phrase “in some embodiments” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present embodiment of the specification also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The specification can take the form of an entirely hardware embodiment, an entirely software embodiment or an embodiment containing both hardware and software elements. In a preferred embodiment, the specification is implemented in software, which includes but is not limited to firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description of the embodiments of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats. Furthermore, as will be apparent to one of ordinary skill in the relevant art, the modules, routines, features, attributes, methodologies and other aspects of the disclosure can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the disclosure is in no way limited to implementation in any specific programming language, or for any specific operating system or environment. Accordingly, the disclosure is intended to be illustrative, but not limiting, of the scope of the specification, which is set forth in the following claims.

1. A computer-implemented method comprising:
receiving, with one or more processors, from a client device of a first user, event information for scheduling an event;
scheduling, with the one or more processors, the event based on the event information;
analyzing, with the one or more processors, the event information;
performing, with the one or more processors, a search on a database of advertisements based on analyzing the event information;
identifying, with the one or more processors, from the database of advertisements, a first advertisement of a venue suitable as a location for the event to take place in based on the search;
transmitting, with the one or more processors, instructions to the client device of the first user that cause a display of the first advertisement of the venue as a suggestion to the first user;
receiving, with the one or more processors, from the client device of the first user, a selection of the first advertisement of the venue; and
responsive to receiving the selection of the first advertisement of the venue, updating, with the one or more processors, on the event to include the venue as the location where the event is to take place.

2. The computer-implemented method of claim 1, wherein the event information for scheduling the event includes a number of event attendees invited to participate in the event.

3. The computer-implemented method of claim 1, wherein the event information for scheduling the event includes an event time.

4. The computer-implemented method of claim 1, wherein the event information for scheduling the event includes an event date and an event title.

5. The computer-implemented method of claim 1, further comprising:
receiving profile information of the first user; and
wherein performing the search on the database of advertisements is also based on the profile information of the first user.

6. The computer-implemented method of claim 1, further comprising:
receiving additional information event;
analyzing the additional information;
performing the search on the database of advertisements based on analyzing the additional information;
identifying a second advertisement based on the search; and
updating the suggestion with the second advertisement.

7. The computer-implemented method of claim 1, wherein performing the search on the database of advertisements includes:
identifying a keyword based on analyzing the event information; and
performing the search on the database of advertisements based on the keyword.

8. A system comprising:
one or more processors;
a memory storing instructions that, when executed by the one or more processors, cause the system to:
receive, from a client device of a first user, event information for scheduling an event;
schedule the event based on the event information;
analyze the event information;
perform a search on a database of advertisements based on analyzing the event information;
identify, from the database of advertisements, a first advertisement of a venue suitable as a location for the event to take place in based on the search;
display, on the client device of the first user, the first advertisement of the venue as a suggestion to the first user;
receive, from the client device of the first user, a selection of the first advertisement of the venue; and
responsive to receiving the selection of the first advertisement of the venue, update the event to include the venue as the location where the event is to take place.

9. The system of claim 8, wherein the event information for scheduling event includes a number of event attendees invited to participate in the event.

10. The system of claim 8, wherein the event information for scheduling the event includes an event time.

11. The system of claim 8, wherein the event information for scheduling the event includes an event date event and an event title.

12. The system of claim 8, wherein the instructions further cause the system to:
receive profile information of the first user; and
wherein to perform the search on the database of advertisements is also based on the profile information of the first user.

13. The system of claim 8, wherein the instructions further cause the system to:
receive additional information event;
analyze the additional information;
perform the search on the database of advertisements based on analyzing the additional information;
identify a second advertisement based on the search; and
update the suggestion with the second advertisement.

14. The system of claim 8, wherein to perform the search on the database of advertisement, the instructions further cause the system to:
identify a keyword based on analyzing the event information; and
perform the search on the database of advertisements based on the keyword.

15. A computer program product comprising a non-transitory computer usable medium including a computer readable program, wherein the computer readable program when executed on a computer causes the computer to perform steps comprising:
receiving, from a client device of a first user, event information for scheduling an event;
scheduling the event based on the event information;
analyzing the event information;
performing a search on a database of advertisements based on analyzing the event information;
identifying, from the database of advertisements, a first advertisement of a venue suitable as a location for the event to take place in based on the search;
transmitting instructions to the client device of the first user that cause a display of the first advertisement of the venue as a suggestion to the first user;
receiving, from the client device of the first user, a selection of the first advertisement of the venue; and
responsive to receiving the selection of the first advertisement of the venue, updating the event to include the venue as the location where the event is to take place.

16. The computer program product of claim 15, wherein the event information for scheduling the event includes an event time.

17. The computer program product of claim 15, wherein the event information for scheduling the event includes an event date and an event title.

18. The computer program product of claim 15, further comprising:
receiving profile information of the first user; and
wherein to perform the search on the database of advertisements is also based on the profile information of the first user.

19. The computer program product of claim 15, further comprising:
receiving additional information event;
analyzing the additional information;
performing the search on the database of advertisements based on analyzing the additional information;
identifying a second advertisement based on the search; and
updating the suggestion with the second advertisement.

20. The computer program product of claim 15, wherein performing the search on the database of advertisements includes:
identifying a keyword based on analyzing the event information; and
performing the search on the database of advertisements based on the keyword.
